(19) United States
(12) Patent Application Publication
(10) Pub. No.: US 2010/0260021 A1
(43) Pub. Date: Oct. 14, 2010

(54) INFORMATION RECORDING APPARATUS, INFORMATION RECORDING METHOD, AND INTEGRATED CIRCUIT

(76) Inventors: Hiroshi UEDA, Nara (JP); Motoshi ITO, Osaka (JP)

Correspondence Address: WENDEROTH, LIND & PONACK L.L.P., 1030 15th Street, N.W., Suite 400 East, Washington, DC, 20005-1503, US

(21) Appl. No.: 12/759,055

(22) Filed: Apr. 13, 2010

(30) Foreign Application Priority Data
Apr. 14, 2009 (JP) 2009-097854

(51) Int. Cl. G11B 20/00

(52) U.S. Cl. 369/47.15; G9B/20

(57) ABSTRACT

An information recording apparatus includes a recording access setting section that executes an operation for setting parameters to be applied during a period of time that the recording section executes a recording operation, prior to the recording operation, and a successive recording control section that controls the verification section and the recording section such that a verification operation for recorded data and the recording operation for data to be recorded next are executed successively. The successive recording control section controls the recording access setting section such that the recording access setting section simultaneously executes the setting operation for the recording operation to be executed for the data to be recorded next in the period of time that the verification section executes the verification operation.

### BACKGROUND OF THE INVENTION

1. Field of the Invention

The present invention relates to an information recording apparatus, an information recording method and an integrated circuit for recording information on an information recording medium such as an optical disc.

2. Description of the Background Art

Examples of an information recording medium may include optical discs such as a BD (Blu-ray Disc), a DVD (Digital Versatile Disc) and a CD (Compact Disc).

Recently, video information and audio information tend to be digitized, and therefore a large quantity of digital data is utilized frequently. In response to this digitization, a DVD (Digital Versatile Disc), which is one example of optical discs, is required to ensure an ability to quickly record video data in real time and an ability to store a large quantity of digital data. However, such an optical disc is an exchangeable medium, and therefore needs to overcome reduction in reliability because of dirt and dust.

Conventionally, a write and verification method has been known as a method for recording data on an optical disc such as a DVD. This write and verification method is a method for recording data while securing reliability of the data, and involves recording data (information) on an optical disc, reproducing the data from the optical disc, and verifying whether the data can be reproduced correctly.

The conventional write and verification method will be described herein below with reference to the drawings.

FIG. 11 sequentially illustrates the operations in the write and verification method by a conventional information recording apparatus. In FIG. 11, a lateral axis indicates a recording and reproduction direction (an access direction) of an information recording medium while a vertical axis indicates a time.

In FIG. 11, as an example, information is recorded on recording regions corresponding to 32 clusters n through n+31 in a BD (Blu-ray Disc). Herein, each cluster indicates a unit in a case where data is recorded on or reproduced from an optical disc, and also indicates a unit of error correction.

All the regions corresponding to the 32 clusters, each having information recorded thereon, are subjected to a verification operation as to whether the information is recorded correctly. Prior to the verification operation, a seek operation is executed for the BD from the region corresponding to the cluster n+31 to the region corresponding to the cluster n (a recording start position). When the seek operation is completed at the recording start position, the verification operation is executed for each region where information is recorded. When all the regions each having information recorded thereon are subjected to the verification operation, the seek operation is executed again in order to start to record information on subsequent regions. As described above, according to the write and verification method, data is recorded on an information recording medium by repetition of the recording operation, the seek operation, the verification operation and the seek operation. Herein, the seek operation is considered from the viewpoint of time in the vertical axis. The seek operation corresponds to an overhead where none of the recording operation and the verification operation is executed. Hence, it is understood that as a ratio of seek operations in the entire write and verification method is smaller, access performance is improved.

As described above, the conventional write and verification method has a problem of a prolonged recording time due to an extra seek operation and a rotation wait between a verification operation and a recording operation. An influence to be exerted by this problem becomes significant as data to be recorded is large in quantity, as a capacity of a buffer memory is small, or as a speed doubling rate in a recording operation is high.

In order to solve the foregoing problem, JP-A 08-328752 and Japanese Patent No. 2800319 each disclose an example of a method for sequentially executing a verification operation and a recording operation without an extra seek operation and a rotation wait, that is, a method of eliminating a seek operation to be executed prior to a recording operation, thereby starting recording access subsequently to verification access without a seek operation and a rotation wait during a transition from the verification operation to the recording operation. This method will be referred to as a verification and recording successive access method.

The verification and recording successive access method will be described with reference to FIG. 12.

FIG. 12 sequentially illustrates operations in a write and verification method by an information recording apparatus disclosed in JP-A 08-328752. The write and verification method shown in FIG. 12 is different from the typical write and verification method shown in FIG. 11 in a point that a seek operation is not executed during a transition from a verification operation to a recording operation. More specifically, the write and verification method shown in FIG. 12 employs an access method of completing a verification operation executed for a region where information is recorded, and then immediately starting a recording operation to be executed for a subsequent region. (Herein, according to the method disclosed in Japanese Patent No. 2800319, a preparation interval is provided for executing a recording operation. However, this method is essentially identical with the verification and recording successive access method in terms of a point that a seek operation and a rotation wait are omitted.) According to the verification and recording successive access method, therefore, there is no delay due to a period of time for executing a seek operation (and a rotation wait) prior to a recording operation except a delay due to a period of time for executing a seek operation prior to a verification operation. Thus, the improvement in access performance can be expected.

In the conventional verification and recording successive access method disclosed in JP-A 08-328752, as described above, a reduction in an overall time required for recording can be realized in such a manner that the seek operation to be executed prior to each of the verification operation and the recording operation is executed prior to only the verification operation. In order to further reduce the overall time required for recording, it is necessary to reduce the time required for the seek operation to be executed prior to the verification operation because the seek operation is executed prior to the verification operation. Typically, the seek operation accompanying the access requires a shift of an optical head, and additionally causes occurrence of control an overhead prior to and subsequent to the shift. FIG. 13 illustrates the overhead which occurs in the seek operation.

As shown in FIG. 13, the delay due to the seek operation includes a delay due to return after execution of a recording operation, a delay due to a shift of an optical head, a delay due to a setting operation for recording access, and a delay due to a standby time (a rotation wait) until the optical head reaches a target region. Herein, the delay due to the setting operation for recording access includes a delay due to change of a rotation control mode of a disc motor, a delay due to an operation for setting a waveform of a laser light emitted in recording access, and a delay due to change of a mode of a laser drive circuit. The delay due to the change of the rotation control mode of the disc motor refers to a delay due to a time required for changing the rotation control mode of the disc motor from a constant rotation mode based on a fixing clock to a CLV mode in which the rotation is controlled in synchronization with a signal reproduced from an optical disc. Moreover, the delay due to the operation for setting the waveform of the laser light emitted in recording access refers to a delay due to a time required for setting, at hardware, a parameter of a power or a waveform of a laser light to be emitted for use in recording access (a recording strategy). Further, the delay due to the change of the mode of the laser drive circuit refers to a delay due to a time required for changing the mode of the laser drive circuit from a reproduction only mode to a recordable mode. Thus, a further reduction in an overall time required for recording cannot be expected without reducing an overhead, for example, due to a delay in the setting operation for recording access.

In optical discs having a high-transfer rate and a large capacity, such as a BD, the delay described above causes further degradation in performance. That is, a BD has a transfer rate which is around three times as large as that of a DVD. The three-times transfer rate reduces, to one-third, a period of time that the optical disc is subjected to recording access or verification access. On the other hand, the delay time required until the start of the access occurs without fail irrespective of the transfer rate of the optical disc. As a result, a ratio of the delay time in the case of the BD is larger than that in the case of the DVD. In addition, PC peripherals such as an optical disc drive, and digital home appliances such as a DVD recorder and a BD recorder are becoming increasingly cheaper. Therefore, there is a very strong demand for cost cutting by reduction in capacity of a DRAM (Dynamic Random Access Memory). Particularly, a high-speed and expensive DRAM is required for a medium having a high transfer rate, such as a BD. However, this DRAM exerts a significant influence on costs for an information recording apparatus. For this reason, it becomes very important to bring down costs by reduction in capacity of DRAMs. However, the reduced capacity of the DRAM causes reduction in data buffer size, which leads to shortage of a unit length required for execution of the recording operation or the verification operation. Consequently, a delay occurs frequently prior to the seek operation, the recording access and the verification access.

As described, in the verification and recording successive access method, the degradation in performance caused by the overhead due to, for example, a delay which occurs prior to the seek operation or the verification access becomes significant for an access in the case of adopting a medium with high transfer rate, such as a BD. Moreover, the cost cutting by reducing a capacity of the DRAM also causes a significant degradation in performance caused by the overhead.

### SUMMARY OF THE INVENTION

It is an object of the present invention to provide an information recording apparatus, an information recording method and an integrated circuit, which realize a shorter recording time by reducing an overhead in the verification and recording successive access.

In order to achieve the foregoing object, the information recording apparatus according to one aspect of the present invention includes a recording section that executes a recording operation for recording data on an information recording medium, a verification section that executes a verification operation for verifying that the data recorded by the recording section can be reproduced correctly, a recording access setting section that executes an operation for setting a parameter to be applied in the period of time that the recording section executes the recording operation, prior to the recording operation, and a successive recording control section that controls the verification section and the recording section such that the verification operation for recorded data and the recording operation for data to be recorded next are executed successively. Herein, the successive recording control section controls the recording access setting section such that the recording access setting section simultaneously executes the setting operation for the recording operation to be executed for the data to be recorded next in the period of time that the verification section executes the verification operation.

With the foregoing configuration, the verification operation and the setting operation for recording access are executed simultaneously by using the period of time for the verification operation. As a result, it is not necessary to provide a dedicated period of time for the setting operation for recording access during the period of time for the simultaneous execution. Thus, it is possible to reduce an overhead, for example, due to a delay caused by the setting operation for recording access and therefore to reduce overhead in the access. Hence, it is possible to significantly reduce the overall time required for recording data on an information recording medium in a write and verification manner and to achieve high-speed recording access.

These and other objects, features and advantages of the present invention will become more apparent upon reading the following detailed description along with the accompanying drawings.

### BRIEF DESCRIPTION OF THE DRAWINGS

FIG. 1 shows a configuration of an information recording apparatus according to a first embodiment of the present invention.

FIG. 2 shows a flowchart of one example of an entire procedure in the information recording apparatus according to the first embodiment of the present invention.

FIG. 3 shows a flowchart of one example of data recording in the first embodiment of the present invention.

FIG. 4 shows a flowchart of one example of verification and recording successive access in the first embodiment of the present invention.

FIG. 5 shows a flowchart of one example of a setting for recording simultaneous execution determination process in the first embodiment of the present invention.

FIG. 6 illustrates one example of verification and recording successive access in the first embodiment of the present invention.

FIG. 7 illustrates another example of verification and recording successive access in the first embodiment of the present invention.

FIG. 8 illustrates one example of verification and recording successive access in a second embodiment of the present invention.

FIG. 9 shows a flowchart of one example of a setting for recording concurrent and simultaneous execution determination process in the second embodiment of the present invention.

FIG. 10 shows a flowchart of the verification and recording successive access in the second embodiment of the present invention.

FIG. 11 illustrates a conventional write and verification method.

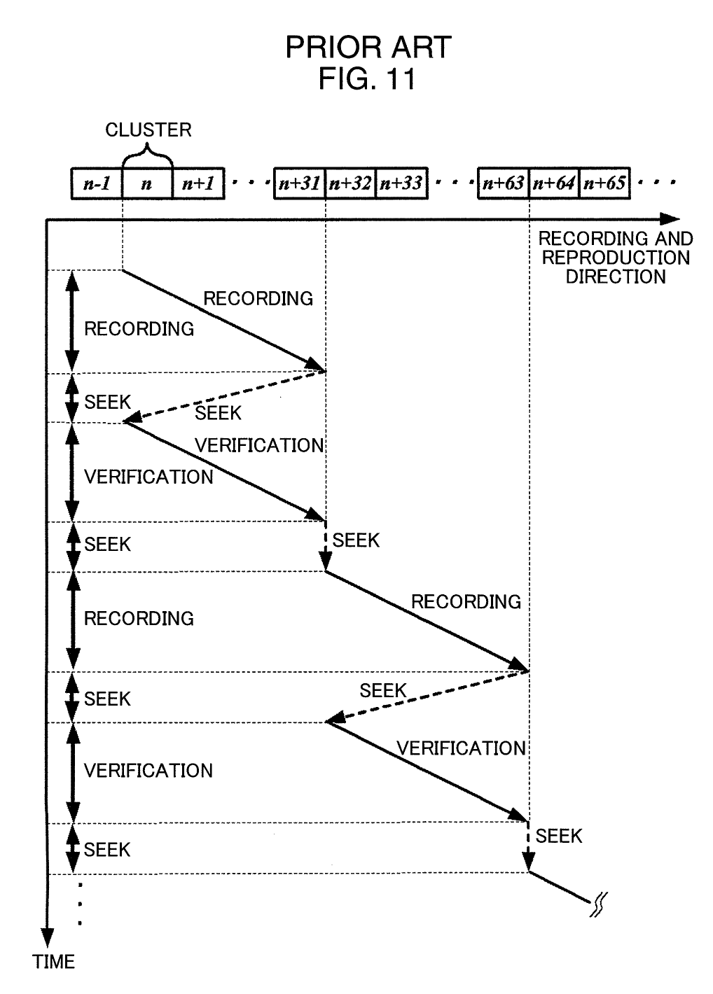

FIG. 12 illustrates a conventional verification and recording successive access method.

FIG. 13 illustrates a delay occurring at a conventional seek operation.

### DETAILED DESCRIPTION OF THE PREFERRED EMBODIMENTS OF THE INVENTION

Embodiments of the present invention are now be explained in detail with reference to the attached drawings. Incidentally, the ensuring embodiments are merely examples that embody the present invention, and are not limited to the technical scope of this invention in any way.

### First Embodiment

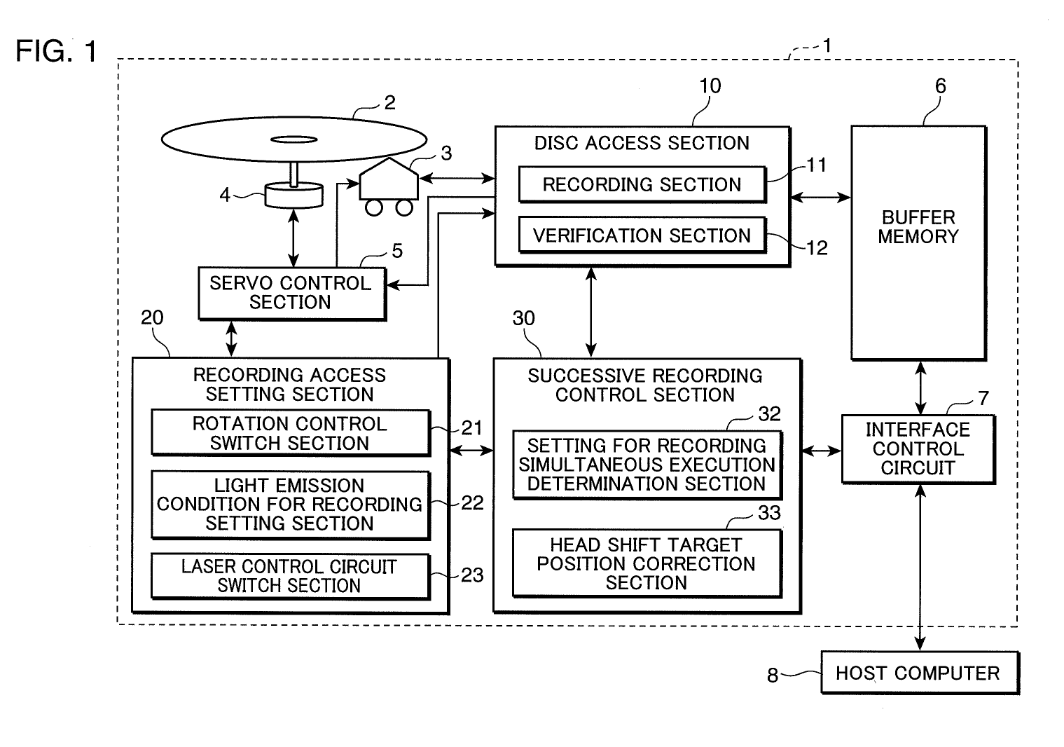

FIG. 1 shows a schematic configuration of an information recording apparatus 1 according to the first embodiment of the present invention. As shown in FIG. 1, the information recording apparatus 1 includes an optical head 3, a disc motor 4, a servo control section 5, a buffer memory 6, an interface control circuit 7, a disc access section 10, a recording access setting section 20 and a successive recording control section 30.

The optical head 3 has a shift mechanism by which the optical head 3 moves to a light spot position where the optical head 3 emits a laser light onto an optical disc 2. The disc motor 4 allows rotation of the optical disc 2. The servo control section 5 controls the optical head 3 and the disc motor 4 in order to optimally adjust a rotation speed, a focus, a track, a seek operation and the like. The buffer memory 6 stores therein data to be recorded on or reproduced from the optical disc 2. The interface control circuit 7 exchanges control information and data with a host computer 8 in accordance with predetermined protocols. The host computer 8 serves as a host controller for the information recording apparatus 1 to send a command to the information recording apparatus 1 such that the information recording apparatus 1 records or reproduces data on or from the optical disc 2. The disc access section 10 serves as a section for performing recording access and verification access on the optical disc 2.

The disc access section 10 includes a recording section 11, and a verification section 12 that verifies data read out from the optical disc 2. The recording access setting section 20 executes an operation for setting a parameter for recording access and an operation for controlling recording access, and includes a rotation control switch section 21, a light emission condition for recording setting section 22 and a laser control circuit switch section 23. The rotation control switch section 21 communicates with the servo control section 5 to change a control mode of the disc motor 4. The light emission condition for recording setting section 22 sets, at the servo control section 5, a power or a waveform of a laser light emitted for use in recording access (recording strategy). The laser control circuit switch section 23 communicates with the servo control section 5 to change a mode of a laser control circuit (not shown) in the optical head 3 to a recordable state.

The successive recording control section 30 sends commands to the disc access section 10 and the recording access setting section 20 in order to execute a procedure for recording data on the optical disc 2 based on verification and recording successive access. In the verification and recording successive access, moreover, the successive recording control section 30 stops a recording operation from being executed on regions subsequent to regions where data recorded thereon is subjected to a verification operation executed by the verification section 12 at a predetermined frequency, in a state in which a setting operation for recording access is not completed. At the timing that the successive recording control section 30 sends a command to the verification section 12 such that the verification section 12 starts executing the verification operation, therefore, the successive recording control section 30 also sends a command to the recording section 11 such that the recording section 11 stops executing the recording operation. Thereafter, the successive recording control section 30 sends an inquiry to the recording access setting section 20 to verify whether the setting operation for recording access is executed completely, and then sends a notification to the recording section 11 such that the recording section 11 starts executing the recording operation. The successive recording control section 30 includes a setting for recording simultaneous execution determination section 32 and a head shift target position correction section 33.

In the recording operation in the verification and recording successive access, the setting for recording simultaneous execution determination section 32 predicts whether the setting operation for recording access can be completed before the verification section 12 completes the verification operation at a predetermined frequency and then the optical head 3 reaches a recording start position of a subsequent region where data is recorded next, prior to a timing that the verification section 12 starts executing the verification operation. This prediction by the setting for recording simultaneous execution determination section 32 is effected based on a comparison between a period of time from the start of the verification operation by the verification section 12 to the start of the recording operation by the recording section 11 subsequent to the completion of the verification operation by the verification section 12 and a period of time required for the execution of the setting operation for recording access by the recording access setting section 20. The head shift target position correction section 33 corrects a shift target position in a case where the optical head 3 moves to a position on the optical disc 2 where the verification operation is executed.

Specifically, when the setting for recording simultaneous execution determination section 32 determines that the setting operation for recording access to be performed after the verification operation cannot be executed simultaneously with the verification operation without occurrence of a delay, the head shift target position correction section 33 corrects the shift target position such that the optical head 3 is located forward by a size of a region on the optical disc 2 (this size corresponds to a period of time for executing the setting operation for recording access).

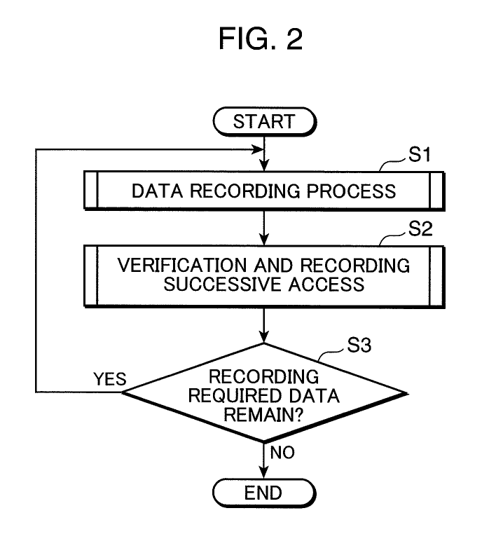

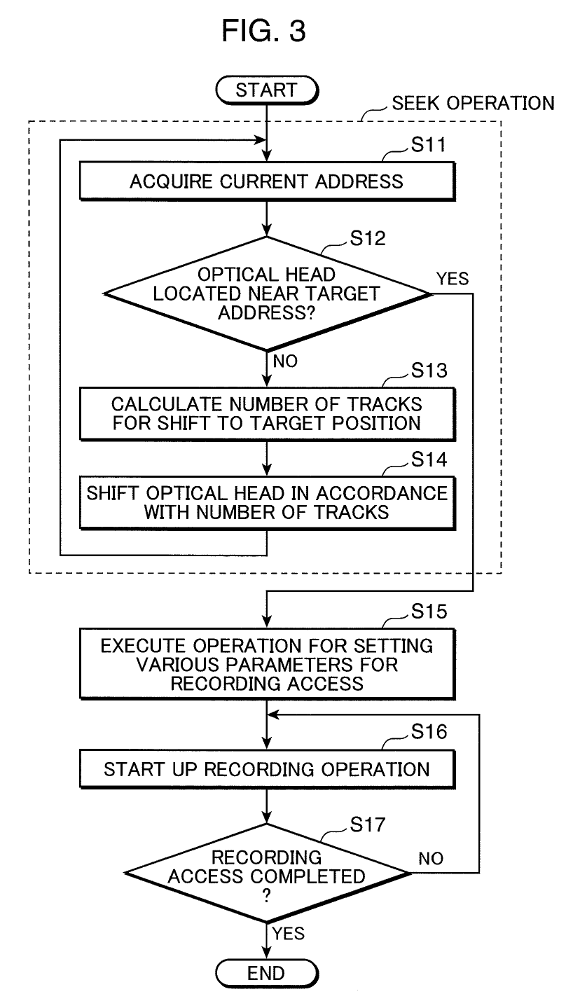

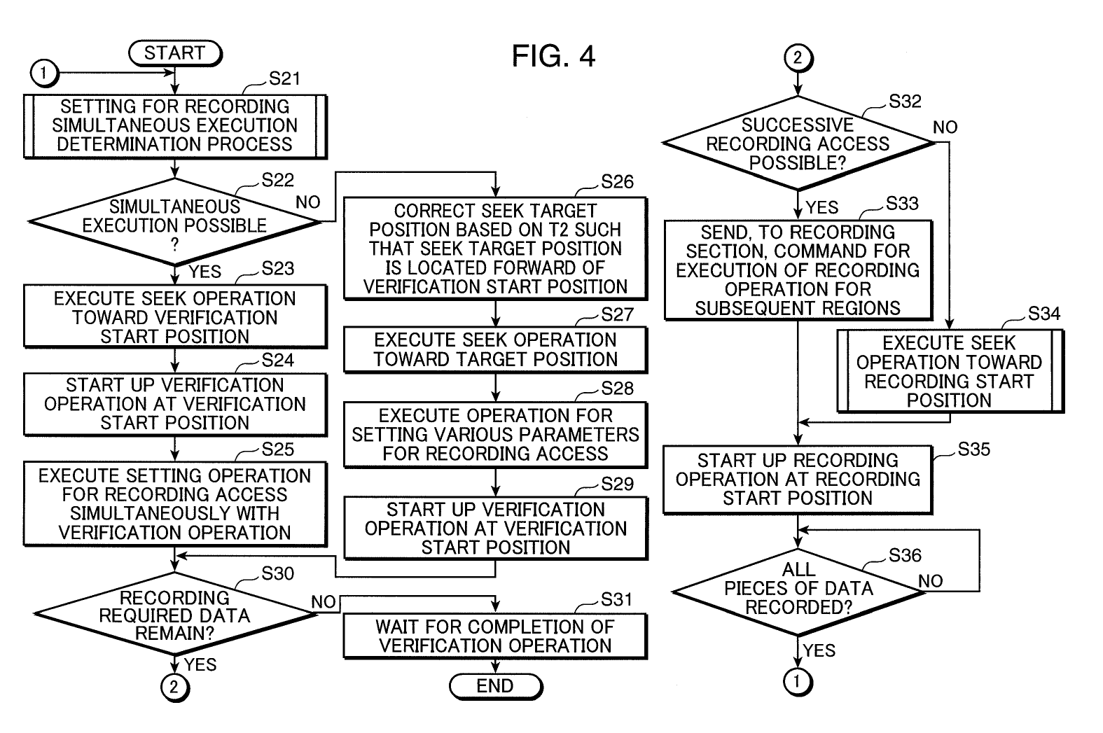

Next, a procedure for recording data on the optical disc 2 in the information recording apparatus 1 according to the present embodiment will be described with reference to flowcharts of FIGS. 2 through 4. FIG. 2 and FIG. 3 each illustrate a typical step of the verification and recording successive access. FIG. 4 illustrates a characteristic step of the verification and recording successive access in the present embodiment.

First, the overall operation of the verification and recording successive access in the information recording apparatus 1 according to the present embodiment will be described with reference to the flowchart of FIG. 2.

In the information recording apparatus 1, in step 1, the interface control circuit 7 receives a command to record target data (hereinafter, referred to as recording data) from the host computer 8, and then transfers the recording data to the buffer memory 6. When transferring the recording data to the buffer memory 6, the interface control circuit 7 sends a command to the successive recording control section 30 in order to record the recording data stored in the buffer memory 6 on the optical disc 2. In accordance with the command from the interface control circuit 7, the successive recording control section 30 sends a command to the disc access section 10 in order to record the recoding data stored in the buffer memory 6 on the optical disc 2. In accordance with the command from the successive recording control section 30, the recording section 11 of the disc access section 10 controls the optical head 3 to record the recording data on the optical disc 2. Details of this process will be described later with reference to the flowchart of FIG. 3.

In a case of recording data in accordance with a write and verification method, typically, a length of data to be recorded and verified successively in one time corresponds to a size of data which can be stored in the buffer memory 6. The reason therefor is that the data stored in the buffer memory 6 cannot be erased until it is verified that the data can be recorded correctly in the verification operation to be executed subsequent to the recording operation. For this reason, the buffer memory 6 has no empty area and therefore fails to receive subsequent recording data. When all the pieces of recording data stored in the buffer memory 6 are recorded on the optical disc 2, the processing routine proceeds to step S2.

In step S2, when receiving a notification that all the pieces of recording data in the buffer memory 6 are recorded on the optical disc 2 from the recording section 11 of the disc access section 10, the successive recording control section 30 sends a command to the verification section 12 of the disc access section 10 such that the verification section 12 executes the verification operation to verify that the data, which is recorded in step S1, can be correctly reproduced from the relevant region. Herein, the verification section 12 controls the optical head 3 to verify that the data, which is recorded in step S1, can be reproduced from the relevant region. When verifying that the recording data can be reproduced correctly, the verification section 12 sends a notification on this verification to the successive recording control section 30 for each error correction unit. When receiving the notification from the verification section 12, the successive recording control section 30 erases the recording data, which can be reproduced correctly, from the memory area of the buffer memory 6, and then sends a command to the interface control circuit 7 such that the interface control circuit 7 transfers subsequent recording data to the empty memory area of the buffer memory 6. The interface control circuit 7 receives subsequent recording data from the host computer 8, and transfers the recording data to the empty area of the buffer memory 6.

Of the plural pieces of recording data which are recorded on the optical disc 2 in step S1, the recording data subjected to the verification operation is successively erased from the buffer memory 6. Instead of the data, data to be recorded on the region subsequent to the region, on which the data is recorded in step S1, in the optical disc 2 is successively stored in the buffer memory 6. When receiving a notification that all the pieces of data recorded in step S1 are subjected to the verification operation from the verification section 12, the successive recording control section 30 sends a command to the recording section 11 such that the recording section 11 starts executing the recording operation for the data to be recorded on the subsequent region. Herein, the recording section 11 controls the optical head 3 so as to record the data on the relevant region of the optical disc 2 immediately after completion of the verification operation. The recording section 11 executes the recording operation until all the pieces of data stored in the buffer memory 6 are recorded on the optical disc 2, and then sends a notification indicative of the completion of the recording operation to the successive recording control section 30. The successive recording control section 30 sends a command to the verification section 12 of the disc access section 10 such that the verification section 12 executes the verification operation for the recorded data. By repeating the foregoing processes, the data, which is transmitted from the host computer 8 so as to be recorded on the optical disc 2, is subjected to the recording operation and the verification operation. All the pieces of data stored in the buffer memory 6 are subjected to the recording operation and the verification operation, the processing routine proceeds to step S3.

Details of the process in step S2 will be described later with reference to the flowchart of FIG. 4.

In step S3, next, the successive recording control section 30 sends, to the interface control circuit 7, an inquiry about whether the interface control circuit 7 receives new data to be recorded (hereinafter, referred to as recording required data) from the host computer 8. When detecting that the interface control circuit 7 has no new recording required data (NO in S3), the successive recording control section 30 determines that all the pieces of recording data are subjected to the recording operation and the verification operation. Thus, the processing routine shown in FIG. 2 is terminated. On the other hand, when detecting that the interface control circuit 7 has new recording required data (YES in S3), the processing routine returns to step S1, and then the process described above is executed again.

FIG. 3 shows a flowchart of a subroutine corresponding to step S1 shown in FIG. 2, that is, details of the procedure for recording data stored in the buffer memory 6 on the optical disc 2. The following description is based on the procedure shown in the flowchart of FIG. 3. It should be noted that the description of step S1 shown in FIG. 2 is appropriately omitted hear to avoid duplication.

In step S11, first, when receiving a command from the successive recording control section 30, the recording section 11 acquires current address information, which is information indicative of a position of the optical head 3 on the optical disc 2, in order to execute the recording operation.

In step S12, next, the recording section 11 determines whether the optical head 3 needs to move to a target position (a position near a start end of a region where data will be recorded), based on the current address acquired in step S11. In other words, the recording section 11 determines whether the optical head 3 is already located at a position near a start end of a region where data will be recorded, i.e., whether the optical head 3 does not need to move. When determining that the optical head 3 is already located at the position near the region where the data will be recorded and therefore does not need to move (YES in S12), the recording section 11 sends a notification indicative of the completion of a seek operation to the successive recording control section 30. Thereafter, the processing routine proceeds to step S15. On the other hand, when the recording section 11 determines that the optical head 3 needs to move (NO in S12), the processing routine proceeds to step S13 in which the recording section 11 calculates the number of tracks required for the shift of the optical head 3.

In step S13, the recording section 11 calculates the number of tracks required for the shift of the optical head 3, from a difference between the current address acquired in step S11 and a leading address of the region where the data will be recorded. Herein, the number of tracks may be calculated by dividing the difference between the current address and the target address (the leading address of the recording region) by the number of sectors per track, for example. Alternatively, the number of tracks may also be calculated from a difference among results of calculation about a track position, which is calculated on the assumption that a track is present for each track pitch from an origin of a disc, with respect to each of the current address and the recording start address.

In step S14, next, the recording section 11 sends a command to the servo control section 5 such that the servo control section 5 shifts the optical head 3 in accordance with the number of tracks calculated in step S13. Herein, when the rotation control mode of the disc motor 4 is a CLV control mode in which the disc motor 4 allows the optical disc 2 to rotate in synchronization with a signal reproduced from the optical disc 2, the recording section 11 sends a command to the servo control section 5 such that the servo control section 5 changes the rotation control mode to a reference clock control mode in which the disc motor 4 allows the optical disc 2 to rotate constantly in synchronization with a reference clock. The change of the rotation control mode allows prevention of the disc motor 4 from being in an abnormal rotation state because the disc motor 4 becomes incapable of correctly reproducing a synchronization signal from the optical disc 2 during the shift of the optical head 3. After completion of the shift of the optical head 3, the processing routine returns to step S11 in which the recording section 11 acquires a current address again.

In step S15, when receiving the notification indicative of the completion of the seek operation from the recording section 11, the successive recording control section 30 sends a command to the recording access setting section 20 such that the recording access setting section 20 executes an operation for setting a parameter required for executing the recording operation (a pre-recording operation). The operation for setting various parameters in the recording access setting section 20 in step S15 will be described herein below.

In order to execute the setting operation for recording access, the rotation control switch section 21 of the recording access setting section 20 sends a command to the servo control section 5 such that the servo control section 5 changes the rotation control mode of the disc motor 4 to the CLV control mode. Herein, the servo control section 5 controls the disc motor 4 such that the optical disc 2 rotates at a speed which is previously set in accordance with a current address, and then changes the rotation control mode using the reference signal reproduced from the optical disc 2.

Next, the light emission condition for recording setting section 22 of the recording access setting section 20 sets a power and a waveform of a laser light emitted for use in recording access (recording strategies) which are optimal for a doubled speed and a radius position in a region where data will be recorded. The light emission condition for recording setting section 22 acquires an optimal recording strategy, based on recording calibration, prior to the recording operation. The light emission condition for recording setting section 22 calculates an optimal parameter for an address of a recording region, based on the data acquired as described above. The light emission condition for recording setting section 22 sends the calculated parameter to the servo control section 5. The servo control section 5 controls the optical head 3 prior to the recording operation.

Next, the laser control circuit switch section 23 of the recording access setting section 20 sends a command to the servo control section 5 in order to change the mode of the laser control circuit (not shown) of the optical heed 3 to the recordable mode. The servo control section 5 sends a command to the optical head 3 such that the laser control circuit is switched to the recordable mode prior to the recording operation.

Upon completing the setting operation for recording access, the recording access setting section 20 sends a notification indicative of the completion of the setting operation for recording access to the successive recording control section 30. Moreover, the recording access control section 20 (the recording servo control parameter setting section) sends a command to the servo control section 5 such that the servo control section 5 controls servo setting to be applied in the recording operation. The servo setting to be applied in the recording operation includes change to a focus position suitable for recording access, attenuator setting for suppressing increase in amount of return light caused by emission of a laser light in the recording operation. Thus, the description of step S15 is finished.

In step S16, when receiving the notification indicative of the completion of the setting process for recording access from the recording access setting section 20, the successive recording control section 30 sends a command to the disc access section 10 such that disc access section 10 starts executing the recording operation. The recording section 11 of the disc access section 10 monitors the current position of the optical head 3 to detect a recording start position and simultaneously start to execute the recording operation. Simultaneously with the start of the recording operation, the recording section 11 adds an error correction code to or modulates the data stored in the buffer memory 6, and sends the resultant data to the optical head 3. Based on the received data, the optical head 3 controls a laser light to be emitted in accordance with the light emission condition for recording access set as described above.

The recording section 11 determines whether all the pieces of data are subjected to the recording operation in accordance with the command from the successive recording control section 30 (S17). When all the pieces of data are subjected to the recording operation (YES in S17), the recording section 11 sends a notification indicative of the completion of the recording operation to the successive recording control section 30. Thus, the recording operation is terminated. On the other hand, when all the pieces of data are not subjected to the recording operation yet (NO in S17), the processing routine returns to step S16. In step S16, the recording operation is performed until all the pieces of data are subjected to the recording operation.

The data recording is completed through the steps described above. Next, the verification and recording successive access (S2 in FIG. 2), which is the characteristic configuration of the present embodiment, will be described with reference to the flowchart of FIG. 4.

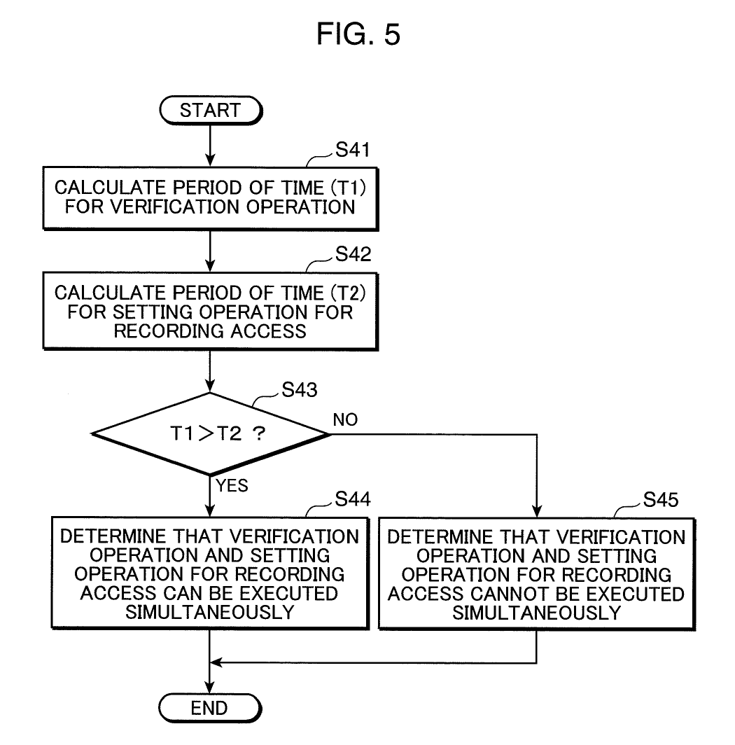

In step S21, first, the setting for recording simultaneous execution determination section 32 of the successive recording control section 30 executes a setting for recording simultaneous execution determination process. More specifically, the setting for recording simultaneous execution determination section 32 determines whether the setting operation for recording access can be completed in the period of time for executing the verification operation. When determining that the setting operation for recording access can be completed in the period of time for executing the verification operation, the setting for recording simultaneous execution determination section 32 determines that the setting operation for recording access and the verification operation can be executed simultaneously. On the other hand, when determining that the setting operation for recording access is not completed in the period of time for executing the verification operation, the setting for recording simultaneous execution determination section 32 determines that the setting operation for recording access and the verification operation are not executed simultaneously. It should be noted that details of this determination process will be described later with reference to a flowchart of FIG. 5.

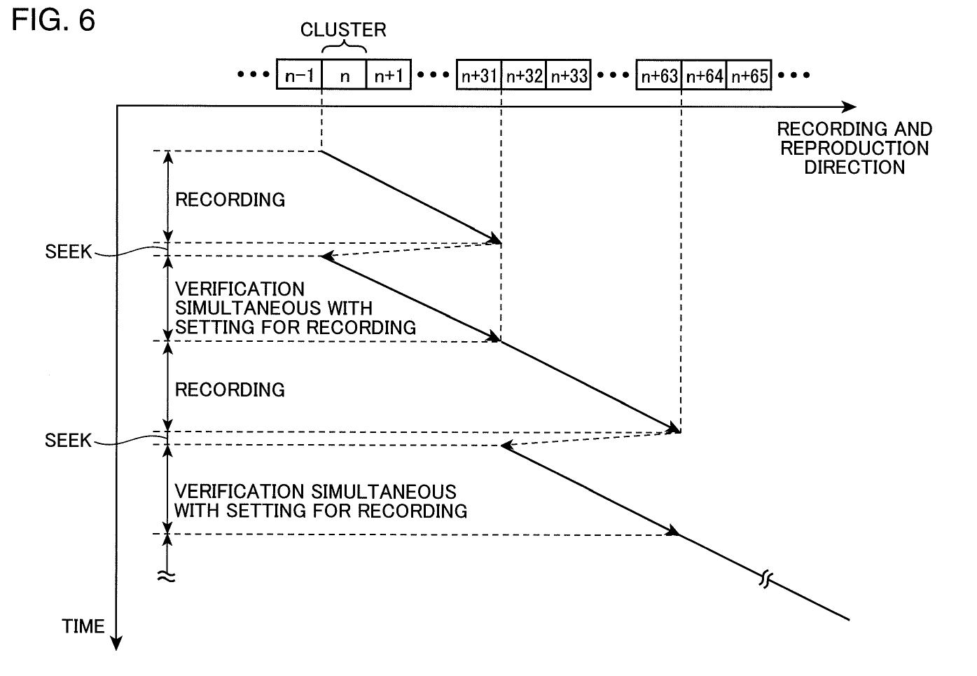

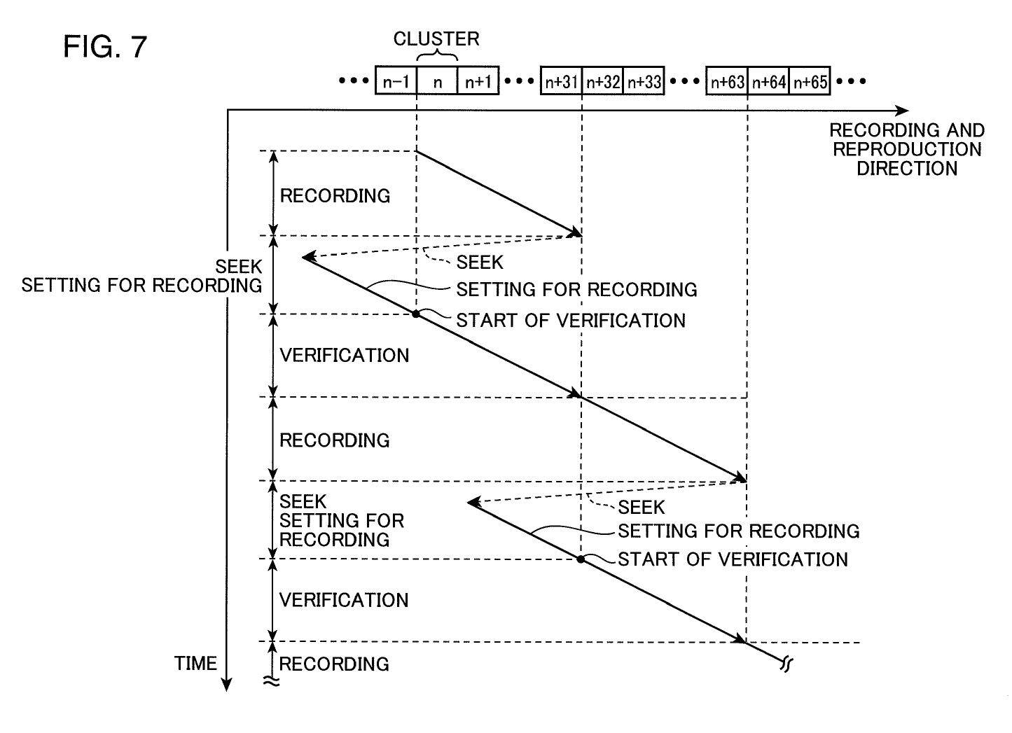

In step S22, next, it is determined that which steps (steps S23 through S25 or steps S26 through S29) are carried out subsequently to step S22, based on the result of determination in step S21. More specifically, when the setting for recording simultaneous execution determination section 32 determines that the setting operation for recording access and the verification operation are executed simultaneously (YES in S22), the processing routine proceeds to steps S23 through S25. FIG. 6 sequentially illustrates steps S23 through S25. On the other hand, when the setting for recording simultaneous execution determination section 32 determines that the setting operation for recording access and the verification operation are not executed simultaneously (NO in S22), the processing procedure proceeds to steps S26 through S29. FIG. 7 sequentially illustrates steps S26 through S29.

In FIG. 6 and FIG. 7, a lateral axis indicates a recording and reproduction direction (an access direction) of an information recording medium while a vertical axis indicates a time. Herein, as an example, information is recorded on recording regions corresponding to 32 clusters n through n+31 in a BD (Blu-ray Disc). Herein, each cluster indicates a unit in a case where data is recorded on or reproduced from an optical disc such as a BD, and also indicates a unit of error correction. In this example, the recording operation and the verification operation are executed every 32 clusters; however, the present invention is not limited to this example. Alternatively, the recording operation and the verification operation may be executed every given number of clusters.

First, steps S23 through S25 shown in FIG. 4 will be described herein below with reference to FIG. 6 in addition to FIG. 4.

In order to execute the verification operation for the region where the data is recorded, the successive recording control section 30 sends a command to the disc access section 10 such that the verification section 12 of the disc access section 10 executes the verification operation. Herein, the successive recording control section 30 brings the successive recording operation for the subsequent region to a suppressed state (a state in which the optical head 3 reaches the recording start position, but does not perform recording access). Then, the verification section 12 of the disc access section 10 executes the seek operation for shifting the optical head 3 to the verification start position (S23). This seek operation corresponds to steps S11 through S14 shown in FIG. 3; therefore, the detailed description thereof will be appropriately omitted here.

In the present embodiment, the successive recording control section 30 includes the head shift target position correction section 33, and therefore can correct the shift target position of the optical head 3 in the seek operation. In step S23, however, the head shift target position correction section 33 sets a normal target position as a verification start position, and the verification section 12 executes the seek operation to shift the optical head 3 to the verification start position.

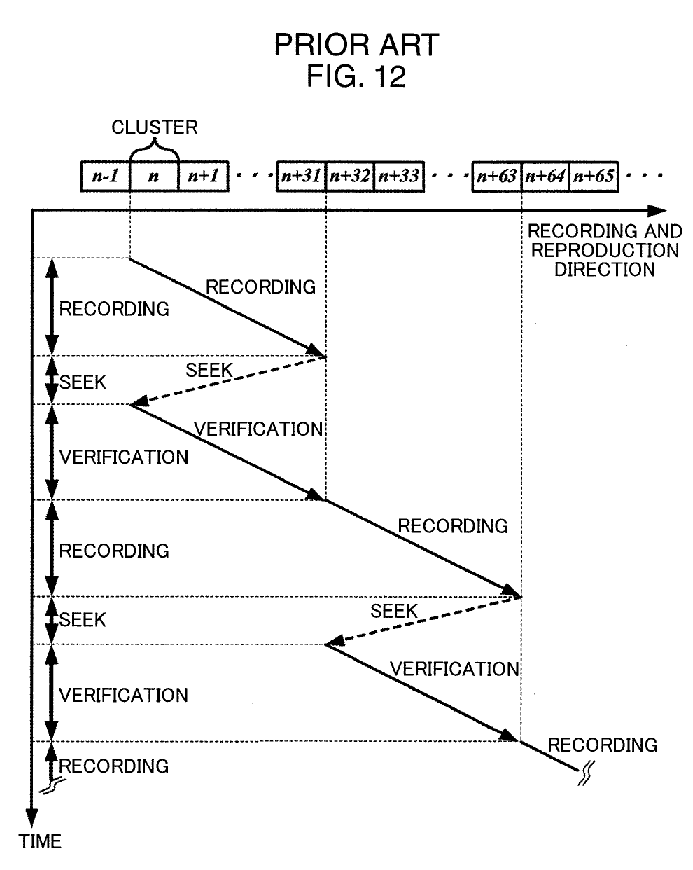

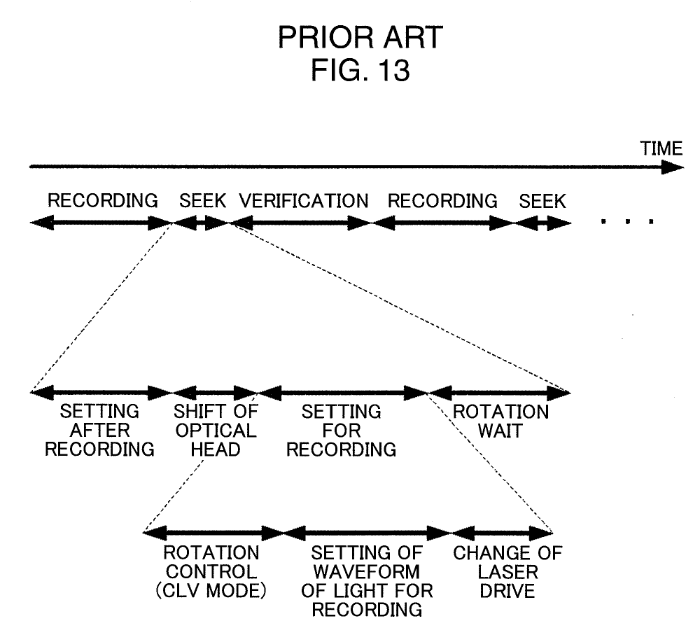

In the foregoing conventional example shown in FIG. 12 and FIG. 13, the setting operation for recording access, and the like are included in the seek operation to be executed prior to the verification operation. In the present embodiment, on the other hand, the setting operation for recording access is not included in the seek operation in step S23. Therefore, the seek operation is completed in a shorter time as compared with the conventional seek operation.

Next, the verification section 12 identifies the position of the optical head 3, detects that the optical head 3 is located at the verification start position, and starts up the verification operation (S24). In this verification operation, the verification section 12 reads out the data from the optical disc 2, decodes the data, performs error correction on the data, and verifies whether the data can be reproduced correctly. When the data cannot be reproduced correctly, the recording operation is executed again or a defect is corrected. However, these processes have no direct relation with the present invention; therefore, description thereof will be appropriately omitted here.

Thereafter, the processing routine proceeds to step S25 in which the recording access setting section 20 executes the operation for setting various parameters for recording access (the setting operation for recording access) simultaneously with the verification operation. This setting operation corresponds to step S15 in FIG. 3; therefore, detailed description thereof will be appropriately omitted here.

In steps S23 through S25, as shown in FIG. 6 in addition to FIG. 4, the verification operation and the setting operation for recording access are executed concurrently and simultaneously in the period of time for the verification operation. As a result, it is not necessary to provide a dedicated period of time for the setting operation for recording access. In other words, it is possible to reduce a delay due to the setting operation for recording access. With the information recording apparatus 1 and the information recording method according to the present embodiment, thus, it is possible to reduce an overall time required for recording by reducing overhead which occurs prior to a verification operation in the verification and recording successive access.

Next, details of steps S26 through S29 shown in FIG. 4 will be described with reference to FIG. 7 in addition to FIG. 4. After completion of the recording operation, the seek operation is executed for shifting the optical head 3 to the position located forward of the verification start position (the upstream side in the recording direction) based on the period of time (T2) for executing the setting operation for recording access. Next, the setting operation for recording access is executed with the optical head 3 shifted in the direction of the verification start position. The setting operation for recording access is completed within the period of time until the optical head 3 reaches the verification start position. When the optical head 3 reaches the verification start position, the verification operation is executed. The details of steps S26 through S29 shown in FIG. 4 are described herein below.

When the setting for recording simultaneous execution determination section 32 determines that the setting operation for recording access cannot be completed in the period of time for executing the verification operation (NO in S22), the processing routine proceeds to step S26. In step S26, the head shift target position correction section 33 corrects the seek target position such that the seek target position is located further forward of the verification start position, and then sends a notification indicative of the correction to the verification section 12. Herein, the amount of correction by the head shift target position correction section 33 is determined based on the period of time (T2) for executing all the setting operation for recording access. That is, the head shift target position correction section 33 corrects the shift target position of the optical head 3 such that the optical head 3 is located further forward of the verification start position by a distance corresponding to the number of sectors through which the optical head 3 passes in the period of time (T2) for executing all the setting operation for recording access. In the case where the setting for recording simultaneous execution determination section 32 determines that the setting operation for recording access cannot be completed in the period of time for executing the verification operation, as described above, the head shift target position correction section 33 corrects the shift target position of the optical head 3 such that the optical head 3 is located forward by an amount, which is calculated from the period of time (T2) for executing all the setting operation for recording access and a constant linear velocity in the region where the data recorded thereon is subjected to the verification operation, as compared with the case where the setting for recording simultaneous execution determination section 32 determines that the setting operation for recording access can be completed within the period of time for executing the verification operation.

Next, the verification section 12 executes the seek operation to shift the optical head 3 to the shift target position corrected in step S26 (S27), and then the processing routine proceeds to step S28. The seek operation corresponds to steps S11 through S14 shown in FIG. 3; therefore, detailed description thereof will be appropriately omitted here. In step S28, the recording access setting section 20 executes the operation for setting the various parameters for recording access (the setting operation for recording access) prior to the verification operation. The setting operation for recording access is completed before the optical head 3 reaches the verification start position. The setting operation for recording access corresponds to step S15 shown in FIG. 3; therefore, detailed description thereof will be omitted here. Next, the verification section 12 detects that the optical head 3 is located at the verification start position, and then starts up the verification operation (S29).

In steps S26 through S29, likewise, the successive recording control section 30 brings the successive recording operation for the subsequent region to a suppressed state (a state in which the optical head 3 reaches the recording start position, but does not perform recording access) in the case of sending a command to the disc access section 10 such that the verification section 12 of the disc access section 10 executes the verification operation.

Steps subsequent to step S25 or S29 will be described herein below. Subsequent to the verification operation and the setting operation for recording access which are executed simultaneously in step S25 or the verification operation in step S29, the successive recording control section 30 determines whether there is data to be recorded successively on the subsequent region (S30). When no recording data remains (NO in S30), the processing routine proceeds to step S29. On the other hand, when recording data still remains (YES in S30), the processing routine proceeds to step S32.

In the case where no recording data remains (NO in S30), the successive recording control section 30 determines that all the pieces of data are recorded on the optical disc 2, and identifies that the verification operation is completed (S31). Thus, this process is terminated.

On the other hand, in the case where recording required data still remains (YES in S30), the successive recording control section 30 determines whether the recording operation can be executed subsequently to the verification operation after completion of the operation for setting the various parameters for recording access (the setting operation for recording access) in step S25 (S32). In a case where the verification operation is already completed before the setting operation for recording access is completed in step S25 and therefore the optical head 3 passes through the recording start position, the recording operation for recording cannot be executed successively. Therefore, the successive recording control section 30 determines that successive recording access is impossible. On the other hand, in a case where the verification operation is under execution upon completion of the setting operation for recording access in step S25 and therefore there is a predetermined temporal allowance until the optical head 3 reaches the recording start position, the successive recording control section 30 determines that successive recording access is possible. When the successive recording control section 30 determines that successive recording access is possible (YES in S32), the processing routine proceeds to step S33. On the other hand, when the successive recording control section 30 determines that successive recording access is impossible (NO in S32), the processing routine proceeds to step S34.

In the case where the recording operation can be executed subsequently to the verification operation (YES in S32), the successive recording control section 30 sends a command to the disc access section 10 such that the recording section 11 of the disc access section 10 performs recording access on the region subsequent to the region subjected to verification access, simultaneously with completion of the verification operation (S33). Thereafter, the processing routine proceeds to step S35.

On the other hand, when determining that successive recording access is impossible (NO in S32), the successive recording control section 30 executes the seek operation at the recording start position in step S34. Thereafter, the processing routine proceeds to step S35. The seek operation corresponds to steps S11 through S14 shown in FIG. 3; therefore, detailed description thereof will be appropriately omitted here.

In step S35, the recording section 11 identifies the current position of the optical head 3 to detect the recording start position and concurrently start to perform recording access. Concurrently with the start of recording access, the recording section 11 adds an error correction code to or modulates the data stored in the buffer memory 6, and sends the resultant data to the optical head 3. Based on the received data, the optical head 3 controls a laser light to be emitted in accordance with the light emission condition for recording access set as described above.

In step S36, next, the successive recording control section 30 verifies whether all the pieces of data stored in the buffer memory 6 are recorded on the optical disc 2. When all the pieces of data are recorded (YES in S36), the processing routine proceeds to step S21 in which the verification operation is executed in order to verify the recorded data. On the other hand, when all the pieces of data are not recorded yet (NO in S36), the recording operation is executed again.

Thus, the description of the verification and recording successive access is finished.

In the foregoing example, information is recorded on a region which is immediately subsequent to a region where information is recorded and a verification operation for the information is completed; however, the present invention is not limited thereto. Alternatively, a gap may be interposed between the region to be subjected to verification access and the region to be subjected to recording access as long as successive access to the optical disc 2 is possible without a rotation wait. In step S33, for example, after completion of the verification operation, the recording operation may be executed when the optical head 3 passes through a predetermined gap region.

In the foregoing example, the recording access setting section 20 executes the operation for setting the various parameters for recording access (the setting operation for recording access) in step S25 and then determines whether successive recording access is possible in step S32; however, the present invention is not limited to this example. Alternatively, the present invention may employ the following configuration. That is, the successive recording control section 30 issues a command about successive recording access in advance, determines whether the setting operation for recording access can be completed before the optical head 3 reaches the recording start position, and suppresses or permits start of recording access, based on the result of determination. In this case, when the setting operation for recording access is completed before the optical head 3 reaches the recording start position, the successive recording control section 30 permits the start of recording access. On the other hand, when the setting operation for recording access is not completed yet, the successive recording control section 30 suppresses the start of recording access.

The information recording apparatus 1 according to the present embodiment completes the operation for setting the various parameters for recording access in step S25, and then verifies whether the recording operation can be executed successively in step S32. Therefore, there is no possibility that recording access is performed in a state of incompletion of the setting operation for recording access. Accordingly, it is possible to constantly ensure high recording quality.

The information recording apparatus 1 according to the present embodiment executes the verification operation in step S24 and simultaneously executes the setting operation for recording access in step S25. The foregoing configuration permits a reduction in delay in the setting operation for recording access to be executed prior to the access for the verification operation and a reduction in an overhead in the access. Accordingly, it is possible to reduce an overall time required for recording data on an information recording medium in a write and verification manner.

The information recording apparatus 1 according to the present embodiment determines whether the verification operation and the setting operation for recording access can be executed simultaneously in step S21 and step S22. This configuration allows verification and recording successive access even in a case where the setting operation for recording access cannot be completed in the period of time for executing the verification operation, and therefore allows suppression of degradation in performance at minimum. That is, if the verification operation and the setting operation for recording access cannot be executed simultaneously (NO in step S22), the setting operation for recording access is executed prior to the verification operation in accordance with steps S26 through S29. This case also allows the verification and recording successive access. (Incidentally, without the foregoing determination process, in the case where the verification operation and the setting operation for recording access are executed simultaneously, but the setting operation for recording access cannot be completed in the period of time for executing the verification operation, the verification operation and the recording operation would be separated from each other with the seek operation in step S34 in between, which would results in degradation in performance.)

In the information recording apparatus 1 according to the present embodiment, the head shift target position correction section 33 corrects the shift target position of the optical head 3 in step S26. Therefore, it is possible to constantly execute a seek operation at an optimal position without an unnecessary rotation wait and a retry of a seek operation.

FIG. 5 shows a flowchart of details of the setting for recording simultaneous execution determination process in step S21. The setting for recording simultaneous execution determination process in the present embodiment will be described herein below along with respective steps shown in FIG. 5.

In step S41, first, the setting for recording simultaneous execution determination section 32 of the successive recording control section 30 calculates a time at which the verification section 12 completes the verification operation. As described in step S1 shown in FIG. 2, a unit of an operation for performing recording access or verification access in one time corresponds to a size of data which can be stored in the buffer memory 6. Accordingly, the setting for recording simultaneous execution determination section 32 calculates a constant linear velocity from a doubled speed or a radius position in a region where data recorded thereon is subjected to the verification operation, and then calculates a period of time that the optical head 3 passes the sectors corresponding to the size of the data which can be stored in the buffer memory 6 at the constant linear velocity, as a period of time (T1) for executing the verification operation.

In step S42, next, the setting for recording simultaneous execution determination section 32 calculates a period of time (T2) that the recording access setting section 20 executes the setting operation for recording access. In order to calculate the period of time (T2), information about a time measured in advance is stored in a memory area of the setting for recording simultaneous execution determination section 32. In a case of software processing using a CPU (Central Processing Unit), a utilization factor of the CPU tends to become high as a constant linear velocity is high. In such a case, the period of time (T2) for executing the setting operation for recording access tends to become long as the constant linear velocity is high. For this reason, information about a temporal coefficient or a function for compensating this constant linear velocity dependency is stored in the memory area of the setting for recording simultaneous execution determination section 32. Thus, it is possible to calculate the period of time (T2) more correctly.

In step S43, next, the setting for recording simultaneous execution determination section 32 compares the period of time (T1) calculated in step S41 with the period of time (T2) calculated in step S42. When the period of time (T1) for executing the verification operation is longer than the period of time (T2) for executing the setting operation for recording access (YES in S34), that is, when the setting for recording simultaneous execution determination section 32 determines that the setting operation for recording access can be completed within the period of time for executing the verification operation, the processing routine proceeds to step S44. On the other hand, when the period of time (T2) is longer than or is equal to the period of time (T1), that is, when the setting for recording simultaneous execution determination section 32 determines that the setting operation for recording access cannot be completed within the period of time for executing the verification operation, the processing routine proceeds to step S45.

In the present embodiment, the determination described above is made based on only the relation between the period of time (T1) for executing the verification operation and the period of time (T2) for executing the setting operation for recording access. In actual, a process of adding an error correction code for recording access to data needs to be executed slightly before execution of the recording operation. For this reason, the setting for recording simultaneous execution determination section 32 may determine whether the setting operation for recording access can be completed within the period of time for executing the verification operation, with the process taken into consideration. In step S43, more specifically, the determination described above may be made based on a comparison between the period of time (T1) and a combination of the period of time (T2) with a period of time (T3) required for executing the process of adding the error correction code for recording access to the data.

When the period of time (T1) is longer than the period of time (T2), that is, when the setting operation for recording access can be completed within the period of time for executing the verification operation (YES in S43), the setting for recording simultaneous execution determination section 32 determines that the verification operation and the setting operation for recording access can be executed simultaneously (S44). On the other hand, when the period of time (T2) is longer than or is equal to the period of time (T1), that is, when the setting operation for recording access cannot be completed within the period of time for executing the verification operation (NO in S43), the setting for recording simultaneous execution determination section 32 determines that the verification operation and the setting operation for recording access cannot be executed simultaneously (S45).

Thus, the description of the setting for recording simultaneous execution determination process is finished.

In the present embodiment, the period of time (T2) is calculated from the time measured in advance in step S42; however, the present invention is not limited thereto as long as the period of time required for execution of the setting operation for recording access can be calculated. Alternatively, the period of time (T2) may be calculated in such a manner that a timer of a CPU measures every setting time. Moreover, the present invention may employ adaptive type control that the period of time (T2) is corrected step by step based on a result of measurement of every setting time.

In the present embodiment, the determination is made based on the relation regarding length between the period of time (T1) and the period of time (T2) in step S43; however, the present invention is not limited to this example as long as the determination can be made based on the information described above. Alternatively, the expression for determination may be changed in accordance with an actual apparatus configuration. For example, parameters which are different from each other depending on a doubled speed may be introduced to the expression for determination.

As described above, the information recording apparatus 1 according to the present embodiment estimates the period of time for the verification operation and the period of time for the setting operation for recording access. This configuration allows more correct determination. As a result, the information recording apparatus 1 according to the present embodiment can correctly select a control method capable of completing the recording operation and the verification operation most quickly. Therefore, it is possible to produce an advantage of performing a write and verification method in a shorter time.

Moreover, the respective functional blocks in the present embodiment are typically realized in such a manner that a CPU executes software stored in a memory, but may be realized in a form of LSI which is one example of integrated circuits. The respective functional blocks may be formed into one chip independently of one another, or may be partially or entirely formed into one chip. Herein, the integrated circuit is referred to as an LSI. However, the integrated circuit may also be referred to as an IC, a system LSI, a super LSI or an ultra LSI, depending on a difference in integration degree. Moreover, the integrated circuit is not limited to an LSI, but may be realized using an exclusive-use circuit or a general purpose processor. Further, the integrated circuit may be configured using an FPGA (Field Programmable Gate Array) that can be programmed after fabrication of an LSI or a reconfigurable processor in which connections and settings of circuit cells inside an LSI are reconfigurable. Furthermore, when a circuit integration technique that replaces an LSI becomes available owing to advancement in a semiconductor technology or other derivative techniques, it goes without saying that functional blocks can be integrated using this technique. For example, biotechnologies have a potential of such application.

### Second Embodiment

The second embodiment of the present invention will be described herein below in detail with reference to the drawings. It should be noted that in the second embodiment, constituent members identical with those in the first embodiment are denoted with identical reference numerals; therefore, detailed description thereof will be appropriately omitted here.

An information recording apparatus 1 according to the present embodiment is basically similar in configuration to the information recording apparatus 1 according to the first embodiment shown in FIG. 1. That is, the information recording apparatus 1 includes an optical head 3, a disc motor 4, a servo control section 5, a buffer memory 6, an interface control circuit 7, a disc access section 10, a recording access setting section 20 and a successive recording control section 30.

First, a difference between the first embodiment and the second embodiment will be described. In the first embodiment, when determining that the setting operation for recording access cannot be completed in the period of time for executing the verification operation, the setting for recording simultaneous execution determination section 32 determines that the setting operation for recording access and the verification operation are not executed simultaneously (S21, S22). In this case, the head shift target position correction section 33 corrects the seek target position of the optical head 3, based on the period of time (T2) for executing all the setting operation for recording access, such that the seek target position is located forward of the verification start position (the upstream side in the recording direction) (S26). In the present embodiment, on the other hand, even when determining that a setting operation for recording access cannot be completed in a period of time for execution of a verification operation, a setting for recording simultaneous execution determination section 32 simultaneously executes the setting operation for recording access and the verification operation. However, since a period of time (T2) for executing the setting operation for recording access is longer than a period of time (T1) for executing the verification operation, the setting operation for recording access cannot be completed in the period of time for executing the verification operation when the setting operation for recording access is executed concurrently with the verification operation. In the present embodiment, for this reason, a head shift target position correction section 33 corrects a seek target position of the optical head 3, based on a differential period of time (T2−T1) between the period of time (T2) for executing the setting operation for recording access and the period of time (T1) for executing the verification operation, such that the seek target position is located forward of a verification start position. Thus, the setting operation for recording access is executed prior to the verification operation in consideration of this differential period of time (T2−T1). After start of the verification operation, the verification operation and the setting operation for recording access are executed simultaneously.

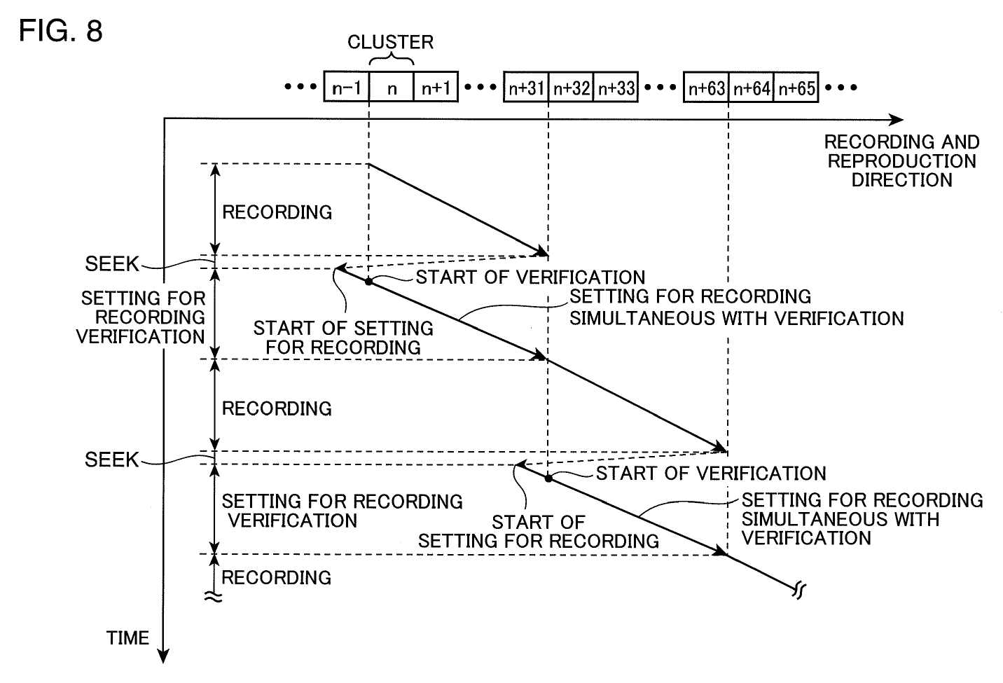

With regard to the information recording apparatus 1 according to the present embodiment, FIG. 8 illustrates verification and recording successive access in the case where the setting for recording simultaneous execution determination section 32 determines that the setting operation for recording access cannot be completed in the period of time for executing the verification operation. As in FIG. 6 and FIG. 7 described above, in FIG. 8, a lateral axis indicates a recording and reproduction direction (an access direction) of an information recording medium while a vertical axis indicates a time. As shown in FIG. 8, with regard to a seek operation to be executed after completion of a recording operation, an amount of shift of the optical head 3 to a position located forward of the verification start position becomes smaller than that in the first embodiment (see FIG. 7). Even in the case where the setting operation for recording access cannot be completed in the period of time for executing the verification operation when the verification operation and the setting operation for recording access are executed simultaneously, the timing of start of the setting operation for recording access and the timing of start of the verification operation are displaced from each other, based on the differential period of time (T2−T1). As a result, the setting operation for recording access can be executed simultaneously with the verification operation by using the period of time for the verification period at maximum. With the information recording apparatus 1 and the information recording method according to the present embodiment, thus, it is possible to significantly reduce a delay due to the setting operation for recording access to be executed prior to the access and to reduce an overhead in the access.

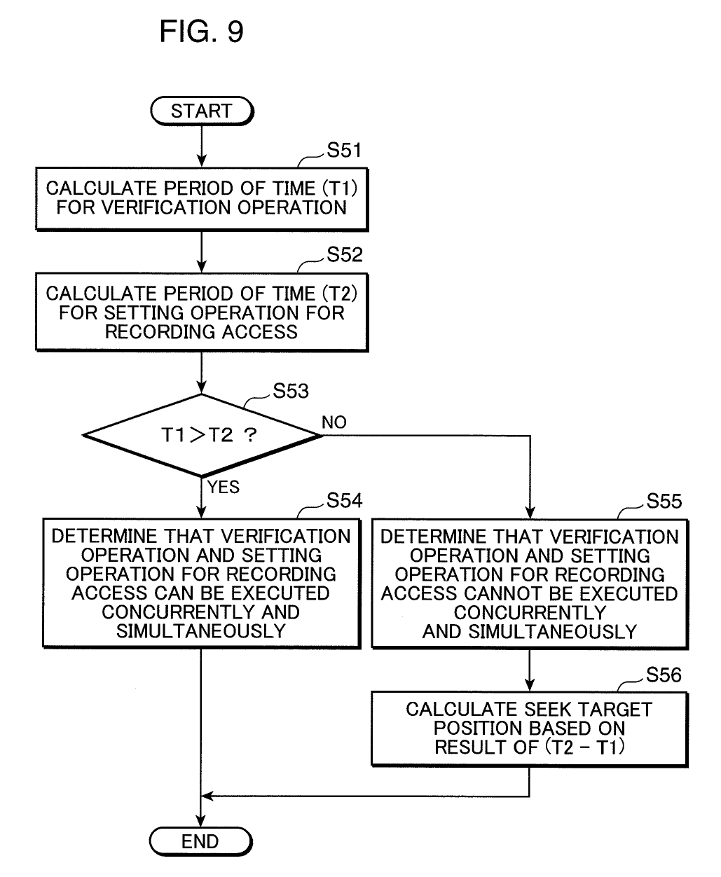

The verification and recording successive access in the present embodiment does not involve determining whether to simultaneously execute the verification operation and the setting operation for recording access, but involves determining whether to simultaneously execute the verification operation and the setting operation for recording access by almost concurrently starting to execute both the operations or simultaneously execute the verification operation and the setting operation for recording access by displacing the timings of start of both the operations from each other. FIG. 9 shows a flowchart of the setting for recording concurrent and simultaneous execution determination process. The setting for recording concurrent and simultaneous execution determination process will be described herein below with reference to FIG. 9.

First, the setting for recording simultaneous execution determination section 32 of the successive recording control section 30 calculates a period of time (T1) during which a verification section 12 executes the verification operation (S51). Next, the setting for recording simultaneous execution determination section 32 calculates a period of time (T2) during which the recording access setting section 20 executes the setting operation for recording access (S52). Next, the setting for recording simultaneous execution determination section 32 determines whether the period of time (T1) is longer than the period of time (T2) (S53). Herein, steps S51 through S53 are similar to steps S41 through S43 shown in FIG. 5; therefore, detailed description thereof will be appropriately omitted here.

Next, when the period of time (T1) is longer than the period of time (T2) (YES in S53), that is, when the setting operation for recording access can be completed within the period of time for executing the verification operation even in the case where the verification operation and the setting operation for recording access are executed concurrently and simultaneously, the setting for recording simultaneous execution determination section 32 determines that both the operations can be executed concurrently and simultaneously (S54). On the other hand, when the period of time (T2) is longer than or is equal to the period of time (T1) (NO in S53), that is, when the setting operation for recording access cannot be completed within the period of time for executing the verification operation in the case where the verification operation and the setting operation for recording access are executed concurrently and simultaneously, the setting for recording simultaneous execution determination section 32 determines that both the operations cannot be executed concurrently and simultaneously (S55). In this case, the head shift target position correction section 33 calculates an amount of correction, based on a differential period of time (T2−T1) between the period of time (T2) and the period of time (T1), such that the seek target position of the optical head 3 is located forward of the verification start position (S56).

Thus, the description of the setting for recording concurrent and simultaneous execution determination process is finished.

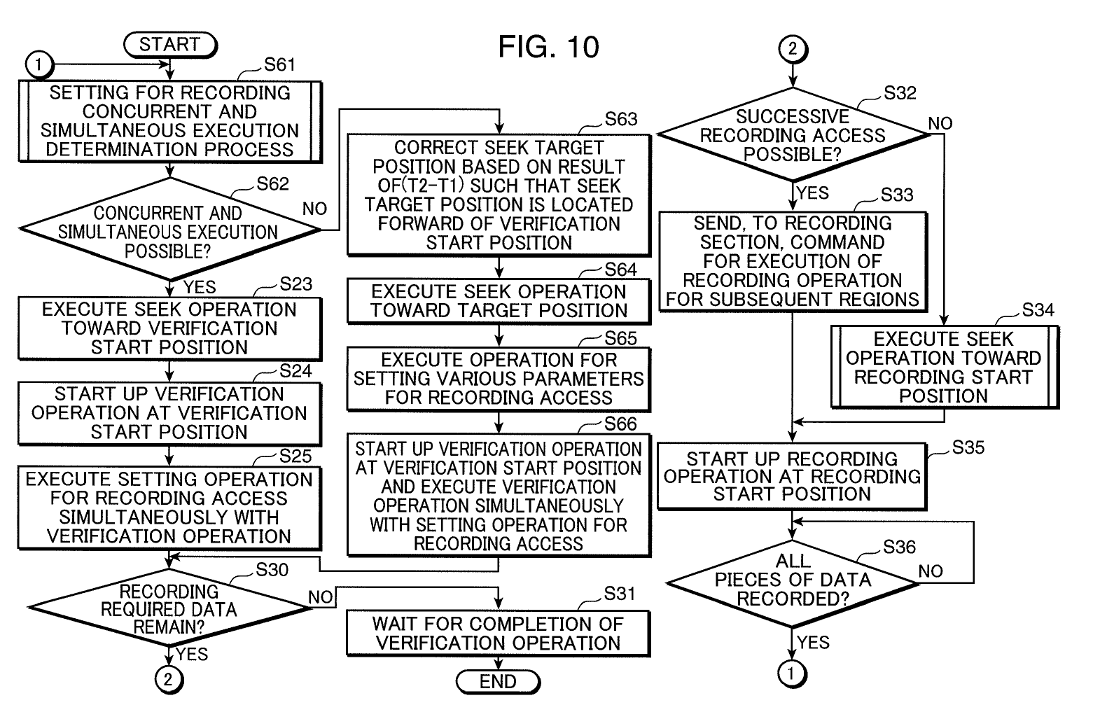

Next, the verification and recording successive access, which is a characteristic configuration of the present embodiment, will be described with reference to a flowchart of FIG. 10.

In step S61, first, the setting for recording simultaneous execution determination section 32 of the successive recording control section 30 executes the setting for recording concurrent and simultaneous execution determination process described above. In step S62, next, it is determined that which steps (steps S23 through S25 or steps S63 through S66) are carried out subsequently to step S62, based on the result of determination in step S61. More specifically, when the setting for recording simultaneous execution determination section 32 determines that the setting operation for recording access and the verification operation can be executed concurrently and simultaneously (YES in S62), the processing routine proceeds to steps S23 through S25. Herein, steps S23 through S25 are similar to those described in the first embodiment with reference to FIG. 4 and FIG. 6. On the other hand, when the setting for recording simultaneous execution determination section 32 determines that the setting operation for recording access and the verification operation cannot be executed concurrently and simultaneously (NO in S62), the processing routine proceeds to steps S63 through S66. FIG. 8 sequentially illustrates steps S63 through S66. Details of these steps will be described herein below.

The head shift target position correction section 33 corrects the seek target position such that the seek target position is located forward of the verification start position (S63), and sends a notification indicative of the correction to the verification section 12. Herein, an amount of correction by the head shift target position correction section 33 is determined based on the differential period of time (T2−T1) between the period of time (T1) for executing the verification operation and the period of time (T2) for executing the setting operation for recording access. More specifically, the head shift target position correction section 33 corrects the shift target position of the optical head 3 such that the shift target position is located forward of the verification start position by a distance corresponding to sectors through which the optical head 3 passes during the differential period of time (T2−T1). As described above, in the case where the setting for recording simultaneous execution determination section 32 determines that the setting operation for recording access cannot be completed in the period of time for executing the verification operation, the head shift target position correction section 33 corrects the shift target position of the optical head 3 such that the shift target position is located forward by an amount calculated from the differential period of time (T2−T1) and a constant linear velocity in a region where data recorded thereon is subjected to the verification operation, as compared with the case where the setting for recording simultaneous execution determination section 32 determines that the setting operation for recording access can be completed in the period of time for executing the verification operation. Step S63 is substantially equal to step S56 shown in FIG. 9. As a result, the shift target position of the optical head 3, which is calculated in step S56, may be used as it is, or step S56 may be omitted.

Next, the verification section 12 executes the seek operation to shift the optical head 3 to the shift target position corrected in step S63 (or S56) (S64). Then, the processing procedure proceeds to step S65. The seek operation corresponds to steps S11 through S14 shown in FIG. 3; therefore, detailed description thereof will be appropriately omitted here. In step S65, the recording access setting section 20 starts executing the setting operation for recording access, prior to the verification operation. The setting operation for recording access corresponds to step S15 shown in FIG. 3; therefore, detailed description thereof will be appropriately omitted here. However, it should be noted here that after carrying out the setting operation for recording access in step S65, the processing routine proceeds to step S66 without waiting for the completion of the setting operation for recording access, so as to execute the setting operation for recording access and the verification operation simultaneously. Namely, upon detecting that the optical head 3 is located at the verification start position, the verification section 12 starts executing the verification operation (S66). After the verification operation is started, the verification operation and the setting operation for recording access are executed simultaneously. Steps subsequent to step S30 are similar to those in the flowchart of FIG. 4; therefore, detailed description thereof will be appropriately omitted here.

As described, the information recording apparatus, the information recording method or the integrated circuit according to the present embodiment allows simultaneous execution of the verification operation and the setting operation for recording access even in the case where the setting operation for recording access cannot be executed concurrently and simultaneously with the verification operation in addition to the case where the setting operation for recording access can be executed concurrently and simultaneously with the verification operation. Thus, it is possible to significantly reduce a delay due to the setting operation for recording access by using the verification period at maximum. Accordingly, it is possible to significantly reduce an overhead in the access, which in turn makes it possible to significantly reduce the overall time required for recording in a write and verification method that employs the verification and recording successive access.

According to one aspect of the present invention, there is provided an information recording apparatus including a recording section that executes a recording operation for recording data on an information recording medium, a verification section that executes a verification operation for verifying that the data recorded by the recording section can be reproduced correctly, a recording access setting section that executes an operation for setting a parameter to be applied in the period of time that the recording section executes the recording operation, prior to the recording operation, and a successive recording control section that controls the verification section and the recording section such that the verification operation for recorded data and the recording operation for data to be recorded next are executed successively. Herein, the successive recording control section controls the recording access setting section such that the recording access setting section simultaneously executes the setting operation for the recording operation to be executed for the data to be recorded next in the period of time that the verification section executes the verification operation.

With this configuration, the recording section and the verification section allow recording of data on an information recording medium in a so-called write and verification manner. Moreover, the successive recording control section allows so-called verification and recording successive access in which a verification operation for recorded data and a recording operation for data to be recorded next are executed successively. In order to realize the verification and recording successive access, the recording access setting section executes the operation for setting the parameter to be applied in the period of time that the recording section executes the recording operation (hereinafter, referred to as the setting operation for recording access) prior to the recording operation. In the present invention, the successive recording control section controls the recording access setting section such that the recording access setting section simultaneously executes the setting operation for recording access in the period of time that the verification section executes the verification operation. As described above, the verification operation and the setting operation for recording access are executed simultaneously by using the period of time for the verification operation. As a result, it is not necessary to provide a dedicated period of time for the setting operation for recording access in the period of time for the simultaneous execution. Thus, it is possible to reduce a delay due to the setting operation for recording access and therefore to reduce an overhead in the access. Hence, it is possible to significantly reduce an overall time required for recording data on an information recording medium in a write and verification manner and to achieve high-speed recording access.

In the foregoing configuration, preferably, the recording access setting section includes a rotation control switch section that switches between a CAV control mode for controlling rotation of the information recording medium based on a reference clock signal and a CLV control mode for controlling the rotation of the information recording medium based on a signal reproduced from the information recording medium, and the rotation control switch section changes the rotation control mode to the CLV control mode in the period of time that the verification section executes the verification operation.

In this case, it is possible to reduce a delay due to the change of the rotation control mode and therefore to achieve high-speed recording access.

In the foregoing configuration, preferably, the recording access setting section includes a light emission condition for recording setting section that sets control information about a power or a waveform of a laser light to be emitted for use in recording access, and the light emission condition for recording setting section sets a light emission condition for recording access so as to achieve a power or a waveform suitable for a region on which data is recorded, in the period of time that the verification section executes the verification operation.

In this case, it is possible to reduce a delay due to the setting for the light emission condition for recording access and therefore to achieve high-speed recording access.

In the foregoing configuration, preferably, the recording access setting section includes a laser control circuit switch section that changes a control status of a laser control circuit of the recording section to a recordable status, and the laser control circuit switch section changes the control status of the laser control circuit to the recordable status during the period of time that the verification section executes the verification operation.

In this case, it is possible to reduce a delay due to the change of the control status of the laser control circuit and therefore to achieve high-speed recording access.

In the foregoing configuration, preferably, the recording access setting section includes a recording servo control parameter setting section that changes a servo control parameter to a parameter for recording access, and the recording servo control parameter setting section changes the servo control parameter to the parameter for recording access in the period of time that the verification section executes the verification operation.

In this case, it is possible to reduce a delay due to the change of the servo control parameter and to therefore achieve high-speed recording access. Herein, examples of the change of the servo control parameter to the parameter for recording access include change to a focus position suitable for recording access, attenuator setting for suppressing increase in amount of return light due to emission of a laser light in recording access, and the like.

In the foregoing configuration, preferably, the successive recording control section suppresses the recording section such that the recording section does not execute the recording operation subsequently to the verification operation until the recording access setting section completes the setting operation for recording access, and after completion of the setting operation for recording access by the recording access setting section, the successive recording control section controls the recording section such that the recording section starts executing the recording operation subsequently to the verification operation.

In this case, it is possible to avoid such a situation that even in a case where the setting operation for recording access cannot be completed before the verification operation is completed, the recording operation is disadvantageously executed subsequently to the verification operation. Thus, it is possible to ensure recording quality.

In the foregoing configuration, preferably, the successive recording control section includes a setting for recording simultaneous execution determination section that determines whether the recording access setting section can complete the setting operation for recording access within the period of time that the verification section executes the verification operation, when the setting for recording simultaneous execution determination section determines that the setting operation for recording access can be completed within the period of time for the verification operation, the successive recording control section allows the recording access setting section to execute the setting operation for recording access simultaneously with the verification operation, and when the setting for recording simultaneous execution determination section determines that the setting operation for recording access cannot be completed within the period of time for the verification operation, the successive recording control section allows the recording access setting section to execute the setting operation for recording access prior to the verification operation.

In this case, even in the case where the setting operation for recording access is not completed during the period of time for the verification operation, the setting operation for recording access is executed prior to the verification operation. Hence, it is possible to apply verification and recording successive access and therefore to achieve high-speed recording access.

In the foregoing configuration, preferably, the successive recording control section includes a setting for recording simultaneous execution determination section that determines whether the recording access setting section can complete the setting operation for recording access within the period of time that the verification section executes the verification operation, when the setting for recording simultaneous execution determination section determines that the setting operation for recording access can be completed within the period of time for the verification operation, the successive recording control section allows the recording access setting section to completely execute the setting operation for recording access simultaneously with the verification operation, and when the setting for recording simultaneous execution determination section determines that the setting operation for recording access cannot be completed within the period of time for the verification operation, the successive recording control section allows the recording access setting section to execute part of the setting operation for recording access prior to the verification operation, based on a differential period of time between the period of time for the setting operation for recording access and the period of time for the verification operation, and after start of the verification operation, allows the recording access setting section to execute the remaining setting operation for recording access simultaneously with the verification operation.

With this configuration, the verification operation and the setting operation for recording access are executed simultaneously in the case where the setting operation for recording access cannot be completed during the period of time for the verification operation in addition to the case where the setting operation for recording access can be completed during the period of time for the verification operation. Thus, it is possible to significantly reduce a delay due to the setting operation for recording access by maximum use of the period of time for the verification operation. Hence, it is possible to significantly reduce an overhead in the access and to significantly reduce an overall time required for recording in the write and verification method that employs the verification and recording successive access.

In the foregoing configuration, preferably, the setting for recording simultaneous execution determination section executes the determination operation in accordance with information about a speed of access by the recording section and the verification section.

In this case, it is possible to correctly execute the determination operation in correspondence with a rotation speed of an information recording medium and therefore to achieve high-speed recording and verification access.

In the foregoing configuration, preferably, the setting for recording simultaneous execution determination section executes the determination operation in accordance with a radius position of an information recording medium to be subjected to recording access or verification access.

In this case, it is possible to correctly execute the determination operation in correspondence with a radius position of an information recording medium to be accessed and therefore to achieve high-speed recording and verification access.

In the foregoing configuration, preferably, the information recording apparatus further includes a data buffer that temporarily stores data therein, and the setting for recording simultaneous execution determination section executes the determination operation in accordance with information about a size of the data buffer.

In this case, it is possible to correctly execute the determination operation in correspondence with a buffer size and therefore to achieve high-speed recording and verification access.

In the foregoing configuration, preferably, the setting for recording simultaneous execution determination section executes the determination operation by calculating a length of one successive verification access from the size of the data buffer and comparing an access period of time corresponding to the length of the successive verification access with the period of time for the setting operation for recording access.

In this case, it is possible to correctly execute the determination operation based on a comparison between a period of time for access and a period of time for setting and therefore to achieve high-speed recording and verification access.

In the foregoing configuration, preferably, the setting for recording simultaneous execution determination section includes a timer that measures a time, and calculates the period of time for the setting operation for recording access, based on a result of measurement by the timer.

In this case, it is possible to correctly execute the determination operation using a time measured by the timer and therefore to achieve high-speed recording and verification access.

In the foregoing configuration, preferably, the information recording apparatus further includes a head shift target position correction section that corrects a target position upon shift of an optical head for use in access, and when the setting for recording simultaneous execution determination section determines that the setting operation for recording access cannot be completed within the period of time for the verification operation, the head shift target position correction section corrects the head shift target position such that the optical head is located forward as compared with the case where the setting for recording simultaneous execution determination section determines that the setting operation for recording access can be completed within the period of time for the verification operation.

In the foregoing configuration, the forward position indicates an upstream side in a recording direction. In the case where the setting operation for recording access cannot be completed within the period of time for the verification operation, the head shift target position is corrected such that the optical head moves forward as compared with the case where the setting operation for recording access can be completed within the period of time for the verification operation. Hence, it is possible to access an information recording medium so as to reduce a rotation wait of the information recording medium, and therefore to achieve high-speed recording and verification access.

In the foregoing configuration, preferably, when the setting for recording simultaneous execution determination section determines that the setting operation for recording access cannot be completed within the period of time for the verification operation, the head shift target position correction section corrects the head shift target position such that the optical head is located forward by an amount calculated from the period of time for the setting operation for recording access and a constant linear velocity in a region where data recorded thereon is subjected to the verification operation, as compared with the case where the setting for recording simultaneous execution determination section determines that the setting operation for recording access can be completed within the period of time for the verification operation.

In this case, the head shift target position correction section calculates the amount of correction of the target position upon shift of the optical head, based on the period of time for the setting operation for recording access and the constant linear velocity in the region where data recorded thereon is subjected to the verification operation. Then, in the case where the setting operation for recording access cannot be completed within the period of time for the verification operation, the head shift target position correction section corrects the head shift target position such that the optical head moves forward by the calculated amount of correction as compared with the case where the setting operation for recording access can be completed within the period of time for the verification operation. Hence, it is possible to access an information recording medium so as to suppress a rotation wait of the information recording medium as much as possible, and therefore to achieve high-speed recording and verification access.

In the foregoing configuration, preferably, the information recording apparatus further includes a head shift target position correction section that corrects a target position upon shift of an optical head for use in access, and when the setting for recording simultaneous execution determination section determines that the setting operation for recording access cannot be completed within the period of time for the verification operation, the head shift target position correction section corrects the head shift target position such that the optical head is located forward by an amount calculated from the differential period of time and a constant linear velocity in a region where data recorded thereon is subjected to the verification operation, as compared with the case where the setting for recording simultaneous execution determination section determines that the setting operation for recording access can be completed within the period of time for the verification operation.

In this case, the head shift target position correction section calculates the amount of correction of the target position upon shift of the optical head, based on the differential period of time between the period of time for the setting operation for recording access and the period of time for the verification operation and the constant linear velocity in the region where data recorded thereon is subjected to the verification operation. Then, in the case where the setting operation for recording access cannot be completed within the period of time for the verification operation, the head shift target position correction section corrects the head shift target position such that the optical head moves forward by the calculated amount of correction as compared with the case where the setting operation for recording access can be completed within the period of time for the verification operation. Hence, it is possible to access an information recording medium so as to suppress a rotation wait of the information recording medium as much as possible, and therefore to achieve high-speed recording and verification access.

According to another aspect of the present invention, there is provided an information recording method including a recording step of executing a recording operation for recording data on an information recording medium, a verification step of executing a verification operation for verifying that the data recorded in the recording step can be reproduced correctly, a recording access setting step of executing an operation for setting a parameter to be applied during the period of time that the recording operation is executed in the recording step, prior to the recording step, and a successive recording control step of controlling the verification step and the recording step such that the verification operation for recorded data and the recording operation for data to be recorded next are executed successively. Herein, the verification step and the recording access setting step are carried out simultaneously.

In this case, it is possible to reduce a delay due to the setting operation for recording access and therefore to reduce an overhead in the access. Hence, it is possible to significantly reduce an overall time required for recording data on an information recording medium in the write and verification manner and therefore to achieve high-speed recording access.

According to still another aspect of the present invention, there is provided an integrated circuit for controlling an information recording apparatus including a recording section that executes a recording operation for recording data on an information recording medium, a verification section that executes a verification operation for verifying that the data recorded by the recording section can be reproduced correctly, and a recording access setting section that executes an operation for setting a parameter to be applied during the period of time that the recording section executes the recording operation, prior to the recording operation. The integrated circuit includes a circuit that controls the verification section and the recording section such that the verification operation for recorded data and the recording operation for data to be recorded next are executed successively, and a circuit that controls the recording access setting section such that the recording access setting section simultaneously executes the setting operation for the recording operation to be executed for the data to be recorded next in the period of time that the verification section executes the verification operation.

Thus, it is possible to realize an integrated circuit which permits a significant reduction in overall time required for recording when recording data on an information recording medium in a write and verification manner.

The information recording apparatus, the information recording method and the integrated circuit according to the present invention are applicable to use for an optical disc drive capable of recording data in accordance with a write and verification method capable of ensuring reliability of data.

This application is based on Japanese Patent Application No. 2009-097854 filed on Apr. 14, 2009, the contents of which are hereby incorporated by reference.

Incidentally, the specific embodiments and examples provided in the foregoing detailed description of the preferred embodiments are merely explained to clarify the technical content of the present invention. Thus, the present invention should not be narrowly interpreted by being limited to such specific embodiments and examples, and may be variously modified and implemented within the spirit of this invention and the scope of claims provided below.

What is claimed is:

1. An information recording apparatus comprising:
a recording section that executes a recording operation for recording data on an information recording medium;
a verification section that executes a verification operation for verifying that the data recorded by the recording section can be reproduced correctly;
a recording access setting section that executes an operation for setting a parameter to be applied during the period of time that the recording section executes the recording operation, prior to the recording operation; and
a successive recording control section that controls the verification section and the recording section such that the verification operation for recorded data and the recording operation for data to be recorded next are executed successively, wherein:
the successive recording control section controls the recording access setting section such that the recording access setting section simultaneously executes the setting operation for the recording operation to be executed for the data to be recorded next in the period of time that the verification section executes the verification operation.

2. The information recording apparatus according to claim 1, wherein:
the recording access setting section includes a rotation control switch section that switches between a CAV control mode for controlling rotation of the information recording medium based on a reference clock signal and a CLV control mode for controlling the rotation of the information recording medium based on a signal reproduced from the information recording medium, and
the rotation control switch section changes the rotation control mode to the CLV control mode during the period of time that the verification section executes the verification operation.

3. The information recording apparatus according to claim 1, wherein:
the recording access setting section includes a light emission condition for recording setting section that sets control information about a power or a waveform of a laser light to be emitted for use in recording access, and
the light emission condition for recording setting section sets a light emission condition for recording access so as to achieve a power or a waveform suitable for a region on which data is recorded, during the period of time that the verification section executes the verification operation.

4. The information recording apparatus according to claim 1, wherein:
the recording access setting section includes a laser control circuit switch section that changes a control status of a laser control circuit of the recording section to a recordable status, and
the laser control circuit switch section changes the control status of the laser control circuit to the recordable status during the period of time that the verification section executes the verification operation.

5. The information recording apparatus according to claim 1, wherein:
the recording access setting section includes a recording servo control parameter setting section that changes a servo control parameter to a parameter for recording access, and
the recording servo control parameter setting section changes the servo control parameter to the parameter for recording access during the period of time that the verification section executes the verification operation.

6. The information recording apparatus according to claim 1, wherein:
the successive recording control section suppresses the recording section such that the recording section does not execute the recording operation subsequently to the verification operation until the recording access setting section completes the setting operation for recording access, and
after completion of the setting operation for recording access by the recording access setting section, the successive recording control section controls the recording section such that the recording section starts executing the recording operation subsequently to the verification operation.

7. The information recording apparatus according to claim 1, wherein:
the successive recording control section includes a setting for recording simultaneous execution determination section that determines whether the recording access setting section can complete the setting operation for recording access within the period of time that the verification section executes the verification operation,
when the setting for recording simultaneous execution determination section determines that the setting operation for recording access can be completed within the period of time for the verification operation, the successive recording control section allows the recording access setting section to execute the setting operation for recording access simultaneously with the verification operation, and
when the setting for recording simultaneous execution determination section determines that the setting operation for recording access cannot be completed within the period of time for the verification operation, the successive recording control section allows the recording access setting section to execute the setting operation for recording access prior to the verification operation.

8. The information recording apparatus according to claim 1, wherein:
the successive recording control section includes a setting for recording simultaneous execution determination section that determines whether the recording access setting section can complete the setting operation for recording access within the period of time that the verification section executes the verification operation,
when the setting for recording simultaneous execution determination section determines that the setting operation for recording access can be completed within the period of time for the verification operation, the successive recording control section allows the recording access setting section to completely execute the setting operation for recording access simultaneously with the verification operation, and
when the setting for recording simultaneous execution determination section determines that the setting operation for recording access cannot be completed within the period of time for the verification operation, the successive recording control section allows the recording access setting section to execute part of the setting operation for recording access prior to the verification operation, based on a differential period of time between the period of time for the setting operation for recording access and the period of time for the verification operation, and after start of the verification operation, allows the recording access setting section to execute the remaining setting operation for recording access simultaneously with the verification operation.

9. The information recording apparatus according to claim 7, wherein:
the setting for recording simultaneous execution determination section executes the determination operation in accordance with information about a speed of access by the recording section and the verification section.

10. The information recording apparatus according to claim 7, wherein:
the setting for recording simultaneous execution determination section executes the determination operation in accordance with a radius position of an information recording medium to be subjected to recording access or verification access.

11. The information recording apparatus according to claim 7, further comprising
a data buffer that temporarily stores data therein, wherein:
the setting for recording simultaneous execution determination section executes the determination operation in accordance with information about a size of the data buffer.

12. The information recording apparatus according to claim 11, wherein:
the setting for recording simultaneous execution determination section executes the determination operation by calculating a length of one successive verification access from the size of the data buffer and comparing an access period of time corresponding to the length of the successive verification access with the period of time for the setting operation for recording access.

13. The information recording apparatus according to claim 12, wherein:
the setting for recording simultaneous execution determination section includes a timer that measures a time, and calculates the period of time for the setting operation for recording access, based on a result of measurement by the timer.

14. The information recording apparatus according to claim 7, further comprising
a head shift target position correction section that corrects a target position upon shift of an optical head for use in access, wherein:
when the setting for recording simultaneous execution determination section determines that the setting operation for recording access cannot be completed within the period of time for the verification operation, the head shift target position correction section corrects the head shift target position such that the optical head is located forward as compared with the case where the setting for recording simultaneous execution determination section determines that the setting operation for recording access can be completed within the period of time for the verification operation.

15. The information recording apparatus according to claim 14, wherein:
when the setting for recording simultaneous execution determination section determines that the setting operation for recording access cannot be completed within the period of time for the verification operation, the head shift target position correction section corrects the head shift target position such that the optical head is located forward by an amount calculated from the period of time for the setting operation for recording access and a constant linear velocity in a region where data recorded thereon is subjected to the verification operation, as compared with the case where the setting for recording simultaneous execution determination section determines that the setting operation for recording access can be completed within the period of time for the verification operation.

16. The information recording apparatus according to claim 8, further comprising
a head shift target position correction section that corrects a target position upon shift of an optical head for use in access, wherein:
when the setting for recording simultaneous execution determination section determines that the setting operation for recording access cannot be completed within the period of time for the verification operation, the head shift target position correction section corrects the head shift target position such that the optical head is located forward by an amount calculated from the differential period of time and a constant linear velocity in a region where data recorded thereon is subjected to the verification operation, as compared with the case where the setting for recording simultaneous execution determination section determines that the setting operation for recording access can be completed within the period of time for the verification operation.

17. An information recording method comprising:
a recording step of executing a recording operation for recording data on an information recording medium;
a verification step of executing a verification operation for verifying that the data recorded in the recording step can be reproduced correctly;
a recording access setting step of executing an operation for setting a parameter to be applied during the period of time that the recording operation is executed in the recording step, prior to the recording step; and
a successive recording control step of controlling the verification step and the recording step such that the verification operation for recorded data and the recording operation for data to be recorded next are executed successively, wherein:
the verification step and the recording access setting step are carried out simultaneously.

18. An integrated circuit for controlling an information recording apparatus including a recording section that executes a recording operation for recording data on an information recording medium, a verification section that executes a verification operation for verifying that the data recorded by the recording section can be reproduced correctly, and a recording access setting section that executes an operation for setting a parameter to be applied during the period of time that the recording section executes the recording operation, prior to the recording operation,
the integrated circuit comprising:
a circuit that controls the verification section and the recording section such that the verification operation for recorded data and the recording operation for data to be recorded next are executed successively; and
a circuit that controls the recording access setting section such that the recording access setting section simultaneously executes the setting operation for the recording operation to be executed for the data to be recorded next in the period of time that the verification section executes the verification operation.
